(19) United States
(12) Patent Application Publication
(10) Pub. No.: US 2010/0090521 A1
(43) Pub. Date: Apr. 15, 2010

(54) Method for the Calibration of Analogized Valves in a Pressure Control Device

(75) Inventor: Mirco Loos, Elversberg (DE)

Correspondence Address: RATNERPRESTIA, P.O. BOX 980, VALLEY FORGE, PA, 19482, US

(73) Assignee: Continental Teves & Co. oHG, Frankfurt (DE)

(21) Appl. No.: 12/529,584

(22) PCT Filed: Jan. 23, 2008
(86) PCT No.: PCT/EP08/50781

§ 371 Date: Dec. 7, 2009

(30) Foreign Application Priority Data
Mar. 5, 2007 (DE) 102007010514.4

(51) Int. Cl. B60T 13/12; G01L 27/00

(52) U.S. Cl. 303/20; 73/1.72

(57) ABSTRACT

Method in which an electromagnetic valve in an electronically controlled pressure control device is calibrated, wherein the differential pressure prevailing at the valve which is to be calibrated is modulated periodically, and wherein the electrical signal which is present at the valve coil of the valve is evaluated at the valve coil or at an additional measuring coil for the purpose of calibration. Also disclosed is an electronically controlled motor vehicle brake pressure control device in which the above method can be carried out.

### CROSS REFERENCE TO RELATED APPLICATIONS

This application is the U.S. national phase application of PCT International Application No. PCT/EP2008/050781, Jan. 23, 2008, which claims priority to German Patent Application No. DE 10 2007 010 514.4, filed Mar. 5, 2007, the contents of such applications being incorporated by reference herein.

### BACKGROUND OF THE INVENTION

1. Field of the Invention

The invention relates to a motor vehicle brake pressure control device.

2. Description of the Related Art

It is known, inter alia, from DE 10 2005 014 097 A1 to use electrically actuable hydraulic valves with analogue control for controlling hydraulic pressure in ABS control devices for motor vehicle brake systems, and also in what are referred to as vehicle movement dynamics controllers with additional functions such as ESP, etc. These so-called analogue/digital valves (A/D valves) are in principle conventional electromagnetic (solenoid) switching valves which are actuated by means of a pulse-width-modulated (PWM) current in such a way that the valve tappet assumes a floating position. In this way it is possible to control the pressure if the current actuation is carried out in a sufficiently precise and reproducible fashion. This is generally possible without relatively serious problems if the pressure to be applied can be applied by means of a pressure sensor in conjunction with a control loop. It is considerably more difficult to perform a corresponding analogue control method in the pressure circuit to be controlled without a pressure sensor.

An entire series of pressure control methods which deal with the problem of setting the pressure of an A/D valve without a pressure sensor in the circuit to be controlled have already become known in this context. It is known that the opening current of the valve is dependent on the pressure difference at the valve (differential pressure) as well as other parameters. For this reason, the controller, which controls the opening current by electrically setting the current by means of an electronic PWM driver stage, must know the admission pressure, the pressure in the circuit to be controlled (for example in the wheel brake cylinder) and the opening current of the valve. In a hydraulic brake device, to which the invention refers, the admission pressure can in any case be sensed by means of sensors, with the result that the problem is reduced to that of determining the pressure in the circuit to be controlled.

The opening current is known to indicate the current of a valve which is open in the currentless state, which current is just sufficient to keep the valve closed at a specific differential pressure. In order to determine the opening current characteristic curve (current across the differential pressure) or else “to calibrate” the A/D valve which is to be controlled it has already been proposed to carry out an electronically controlled calibration method at least once on the assembly line and/or at the factory and/or in the vehicle. In this context, specific pressure values are predefined and current points which represent the opening current behavior of the valve are determined on a point basis. A correspondingly acquired curve or reference points for this curve can then be stored in the controller of the electronic brake system for later use. However, the calibration process which is described above and is to be carried out individually for each individual valve on the basis of minor manufacturing tolerances which are to be taken into account requires additional time and makes the process of manufacturing the valves which are fabricated in large quantities for brake systems very complex overall.

An entire series of methods with which it is possible to determine the opening current characteristic curve even without pre-calibration of the brake system at the factory of the brake system manufacturer or on the assembly line of the vehicle manufacturer have already been proposed. These methods which are known per se are carried out automatically by means of the electronic controller of the brake system and without external pressure being applied (defined measuring pressures etc.) after installation in the vehicle. Some of these methods are based on the fact that feeding back direct or indirect information about the wheel pressure which is actually brought about by a specific valve current (for example from a pressure sensor) or about the position of the valve tappet (for example a signal of the magnetic circuit of the solenoid valve which is acquired with a pick-up coil). A disadvantage with the last-mentioned methods is that additional costs are incurred for pressure sensors or measuring coils.

The invention has the objective of specifying a calibration method for acquiring calibration values, in particular for an opening current curve, which, after installation in a motor vehicle, can be carried about independently and automatically, triggered by the electronic control unit, with said method being carried out without the use of a pressure sensor or a magnetic/electrical measuring element.

### SUMMARY OF THE INVENTION

An electromagnetic valve (for example a valve which is open in the currentless state or closed in the currentless state) in an electronically controlled pressure control device is calibrated, in that the differential pressure prevailing at the valve which is to be calibrated is modulated periodically, and the electrical signal which is present at the corresponding valve coil is evaluated at the valve coil or at an additional measuring coil for the purpose of calibration. The electrical signal is, in particular, the electrical induction signal and/or the coil current profile and/or the voltage profile at the valve coil or at an additional measuring coil.

During the calibration, an offset current is preferably applied to the valve coil. The offset current is a current of a current source which flows through the valve during the calibration measurement so that said coil can be opened or closed more easily, for example by virtue of hydraulic pressure pulses which act on it. However, this does not mean that this current must necessarily always remain constant. Instead, the procedure adopted according to one exemplary embodiment of the calibration method is such that the current is lowered in accordance with a ramp. During a calibration measurement (recording of a measuring point), the current is also still sufficiently constant when continuous lowering occurs, with the result that it is possible to refer to measurement or calibration at a constant current. However, it is in principle also conceivable to carry out a calibration measurement without an offset current as long as the pressure pulsations are sufficient to bring about a measurable valve reaction. However, the latter will tend to occur somewhat rarely.

The valve coil current is therefore adjusted to a setpoint value which is predefined (with respect to a specific point in time), preferably by means of a current controller. Since a controller does not generally exhibit ideal behavior, the coil current which is adjusted by the controller is changed by a hydraulically initiated tappet movement. If, for example, the tappet is excited periodically, a periodic current profile is then obtained whose amplitude depends, inter alia, on the quality of the controller and on the strength of the excitation. In this context, the instantaneous setpoint value can also be changed continuously in accordance with a curve, which is preferred according to the method. The curve is particularly simply a particularly preferred straight line or ramp.

In this context, the manipulated value which is modulated by the valve movement (for example the coil voltage) and/or the actual value of the current controller are preferably evaluated for the purpose of calibration. In particular, the actual value of the controller which is the valve coil current according to the exemplary embodiment is evaluated. However, it is also possible for the magnetic flux in the region of the magnetic circuit of the valve coil to be measured with magnet sensor means which are known per se. It is thus possible, for example, to arrange a pick-up coil in the magnetic field of the coil.

The valve is preferably calibrated by measuring the opening current or closing current. The opening or closing current is in particular the current which flows when a movement of the valve occurs. Said current is measured at a differential pressure in the vicinity of 0 bar, in particular at less than 0.5 bar. In principle it is not possible to carry out a measurement at a differential pressure of precisely 0 bar according to the inventive method since a specific low differential pressure is required to open the valve which is to be calibrated.

As already mentioned, in order to detect the switching point of the valve the valve coil current is preferably increased or decreased, for example linearly, during the calibration of the valve. In this context, the switching point of the valve is detected by changing the electrical signal which is measured at the valve.

In this context, according to one preferred improvement of the method, it may be necessary for the opening current value or closing current value acquired with the calibration method described above to be corrected (for example by means of an offset) in such a way that said value represents the precise value for a pressure difference of 0 bar within the scope of measuring accuracy. This correction increases the accuracy of the measured value since, as already mentioned above, measurement at precisely 0 bar is inherently not possible, or is only possible given a high-amplitude pressure pulsation.

The periodic differential pressure mentioned above is preferably brought about by a feeding hydraulic pump which acts on the valve and which is, in particular, a component of the pressure control device.

In this context in particular the delivery medium which is discharged from the delivery side of the hydraulic pump and acts on the valve can escape at least partially from the circuit in which the pressure pulses. The effect of this measure is that the pressure on the side of the valve which faces the pump outlet does not increase continuously.

The escaping of the delivery medium from the area between the pump and the calibration valve can preferably be made possible by a further, partially opened electromagnetic valve which is connected to said circuit.

The valve which is to be calibrated is preferably an isolating valve or an inlet valve of an electrical brake control unit.

It is surprisingly possible to boost the amplitude of the change in the differential pressure by means of additional measures. A component which is already present in the device (for example valve, nonreturn valve, orifice, pressure accumulator etc.) is preferably used for this purpose. If the amplitude of the differential pressure is increased by this measure, an increase in the amplitude or change in the amplitude of the electrical measuring signal which is evaluated for the purpose of calibration is advantageously also brought about.

For the boosting described above, the isolating valve is preferably only partially opened when the inlet valve is being calibrated. Here, “partially open” does not mean that the valve is actually open at every pressure. Instead it means that the valve current is selected such that the valve opens at a specific current-dependent differential pressure. The partial opening of the isolating valve which is used for the purpose of boosting is therefore carried out, for example, with a valve current at which the valve already opens at an extremely low differential pressure. If, alternatively, the isolating valve is preferably calibrated, the inlet valve can be partially opened in an analogous fashion in order to boost the differential pressure amplitude. The electrical current which is conducted through the coil of the respective boosting valve for this purpose has a value which corresponds to an opening pressure of preferably approximately 0.5 to approximately 8 bar. This range is particularly preferably between approximately 2 to approximately 4 bar.

The calibration is preferably carried out automatically by the device without external application of pressure after the pressure control device has been installed in a useful application, in particular in a vehicle. This makes it possible to dispense with complex calibration processes during the production of the pressure control device or when the pressure control device is installed in a useful application (for example in a motor vehicle).

The control unit preferably comprises a current control circuit which is known per se and which permits, in particular, multi-channel current control. The current control circuit is particularly preferably equipped with a measuring circuit, known per se, for determining the coil current. Depending on the design and complexity of the current measuring circuit, the coil current can be measured continuously or in an averaged fashion and, if appropriate, adjusted precisely.

The current controller which is used to actuate the A/D valve is used, as it were, “as a sensor”. At the same time, pressure modulation is performed hydrodynamically, in particular by means of the hydraulics of the brake system, for example by means of the pump of the brake system, in such a way that the A/D valve moves the tappet. For this purpose, the differential pressure at the valve is preferably modulated periodically or in a pulsed fashion with an amplitude which opens the A/D valve. The tappet movement of the actuated valve, which results from the periodic opening of the valve, brings about a reaction on the coil current by the voltage which is induced in the valve coil. The current controller then attempts to adjust the actual current back to the predefined setpoint current, said actual current having been changed by the periodic tappet movement which has been brought about. The resulting oscillations of the valve current can then be evaluated by reference to the valve current itself or the manipulated variable (for example the pulse width etc.).

For the calibration, the valve opening time or valve closing time is preferably determined by evaluating the oscillation signal of the coil current curve. For this purpose, in particular the amplitude of the current curve is considered. If, for example, the valve tappet starts to move at a specific point in time when the offset current drops, this can be detected from a higher amplitude of the valve current. This increase in amplitude normally extends over a specific limited offset current range in which the valve can react sensitively to pressure pulsations. However, in principle the curve can also be evaluated in terms of the frequency or other parameters, provided that it still permits a valve movement to be detected with sufficient precision. The offset current which flows at the time of the valve reaction which is detected in this way then corresponds relatively precisely to the searched-for calibration value which is intended to specify the opening current or closing current at a differential pressure in the vicinity of 0 bar.

The method described above describes a possible way of measuring the opening current or closing current of a valve at a differential pressure in the vicinity of 0 bar. According to a further preferred embodiment of the method, a corresponding opening current measurement or closing current measurement is carried out, but this is representative of a differential pressure of greater than 0 bar. This is possible in that, in particular, the previously described decrease in pressure at another valve which is not calibrated is reversed so that the pressure in the region between the pump outlet and the calibration valve increases markedly. This increase in differential pressure occurs during the calibration of an inlet valve when, for example, the isolating valve is closed to a somewhat greater degree than in the case of the 0 bar measurement described above.

The invention also relates to an electronically controlled motor vehicle brake pressure control device having at least one ABS control program. This is in particular a control device for a hydraulic pressure.

### BRIEF DESCRIPTION OF THE DRAWINGS

Further preferred embodiments emerge from the following description of an exemplary embodiment with reference to the figures.

In the drawings:

FIG. 1 is a schematic illustration of a brake device for ABS and ESP control processes, and

FIG. 2 is a diagram of the time profile of the coil current of a valve which is to be calibrated.

### DETAILED DESCRIPTION OF THE PREFERRED EMBODIMENTS

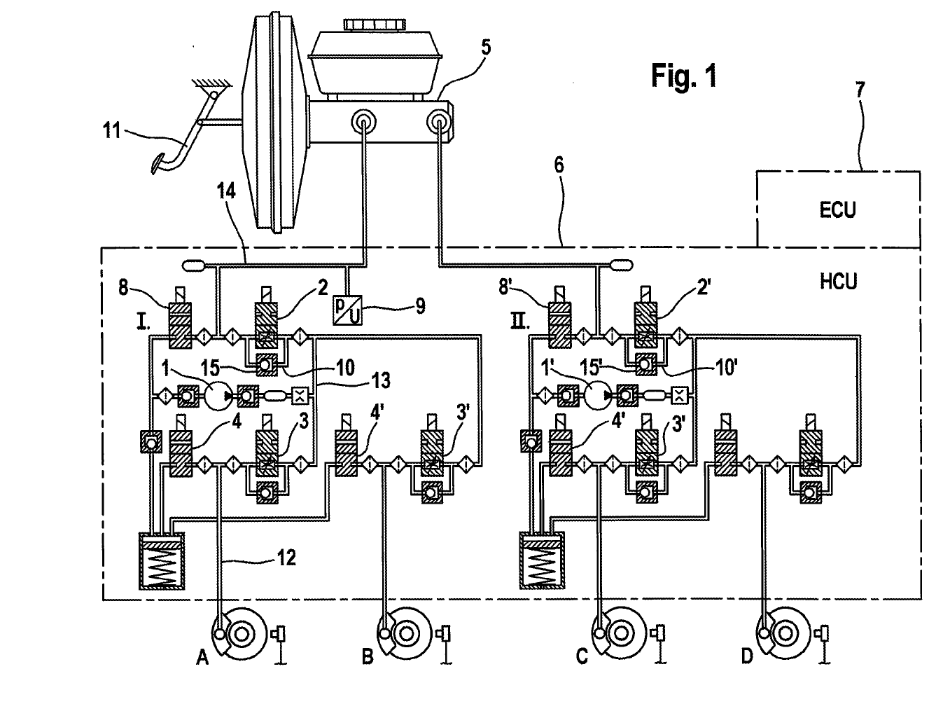

In FIG. 1, the tandem master cylinder 5 is connected to the hydraulic unit 6 (HCU) of an electronic motor vehicle brake system. The electronic unit 7 (ECU) comprises a microprocessor/controller system with which the actuators and sensors which are contained in the valve block can be electronically controlled and/or measured. The hydraulic unit 6 comprises two brake circuits I and II. In addition, each of the brake circuits comprises in each case two wheel pressure circuits (A, B and C, D, respectively) each with an inlet valve 3 or 3′, respectively, and an outlet valve 4 or 4′, respectively. The electronic system of the ECU 7 comprises a multi-channel current controller which permits independent control of the currents through the coils of the valves 2, 2′ (isolating valves) and of the inlet valves (3, 3′). Reference symbols 8 and 8′ respectively denote electronic changeover valves which are closed in the currentless state. In the hydraulic line 8 which leads to the master cylinder 5 there is an input pressure sensor 9. The illustrated brake system does not comprise any further pressure sensors in the wheel brake circuits themselves. Pump 1 and 1′, respectively, can be used for autonomously building up pressure, for example in the case of a TSC or ESP. If pump 1 is switched on, it feeds pressure volume in the direction of the line 13. Owing to the design of the pump, the pressure at the outlet of the pump pulses in a pressure range which is dependent on the design of the hydraulic components.

When the calibration method is carried out, pump 1 is switched on in order to generate pressure pulsations at the valve which is to be calibrated. The calibration is described below using the example of the inlet valve 3. Calibration of other A/D valves, for example of the isolating valve 2, can be carried out in an analogous fashion. The pressure pulsations which occur during the delivery of pressure medium by means of the hydraulic pump result in a periodic differential pressure at the inlet valve 3, and when the inlet valve is completely closed said differential pressure does not yet inevitably cause the inlet valve to open. Periodic tappet movements do not result in a suitable current range until the current through the coil of the isolating valve has dropped, for example, in a ramp shape. The tappet movements occur, in particular, in the region of the equilibrium of forces between the spring force of the restoring spring and the magnetic force of the valve coil. The calibration measurement which is to be performed here for a differential pressure of 0 bar is favorably carried out in a state of the hydraulics in which the pressure in the line 12 is also in the region of atmospheric pressure.

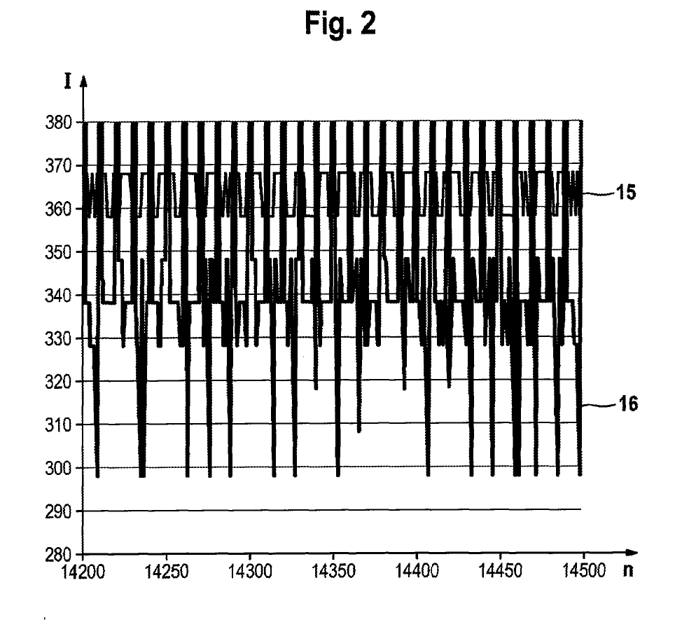

The curves in FIG. 2 represent the time profile of the valve coil current of the inlet valve 3. The number of recorded measured values is plotted on the X axis of the diagram. The X axis can also be understood to be a time axis since the measuring points are recorded at regular, constant time intervals. The Y axis represents the current which is measured in the current controller on the current channel which is assigned to the inlet valve 3.

During the calibration, pump 1 is firstly switched on and a current which corresponds to an opening pressure of approximately 3 bar is applied to the isolating valve 2. The pressure pulsations of the pump 1 pass via the line 13 to the isolating valve 2 and are reflected there. Some of the hydraulic fluid which is fed by the pump 1 can equally escape via valve 2, with the result that the average pressure in the line 13 is not increased far above 0 bar (approximately 0 to 3 bar). The boosted pressure pulsations then pass to the side of the inlet valve 3 which faces the pump.

At the start of the calibration routine, the valve 3 is initially energized with virtually the entire current strength and as a result is essentially completely closed. Since there is no pressure prevailing on the side facing the wheel cylinder, a pulsating pressure difference builds up at the valve 3. The setpoint value for the coil current of the valve 3 is then reduced in accordance with a ramp. The pressure pulsations are still not sufficient to bring about a movement of the tappet of the valve 3. During this time, the current curve of the valve 3 is measured regularly at brief, chronologically equidistant intervals (n measuring points) within the electronic unit. The measured current values are plotted as curve 15 in FIG. 2. Since the PWM current controller oscillates easily, current pulsations with a comparatively small amplitude of approximately 10 measuring units can be discerned. While further measuring points are being recorded, the offset current (setpoint current) in valve coil 3 is reduced slowly in a ramp shape. In a specific current range in which the valve tappet of valve 3 can be moved by the pressure pulsations, the recorded current curve changes. Curve 16 shows the profile of the coil current in the steady state and has an amplitude of over 80 measuring units. For illustrative reasons, the curve is in the same points region as curve 15. However, the curve comprises current values which have been measured at a later point in time. The current range of the offset current at which the current curve with increased amplitude can be detected is used as an opening current of the valve when there is a pressure difference of approximately 0 bar. The calibration process for valve 3 is therefore terminated.

The calibration method described above permits valve calibration in a motor vehicle. Calibration of the valves at the factory or at the motor vehicle manufacturer can advantageously be dispensed with. It is particularly expedient if the calibration method described above is carried out in the run-on of the brake system after the ignition has been switched off or while the vehicle is traveling in suitable situations. A particularly suitable situation occurs, in particular, if the vehicle is in the process of carrying out an acceleration operation. The method is particularly preferably configured in such a way that if the driving situation is unsuitable the calibration process is aborted or interrupted. In these unsuitable driving situations, satisfactory functioning of the brake system has the highest priority. The calibration value which has been determined for a pressure difference of 0 bar can preferably be used to correct an opening current characteristic curve for the valve which has already been stored.

1.-19. (canceled)

20. A method for calibrating an electromagnetic valve in an electronically controlled pressure control device comprising the steps of:
periodically modulating a differential pressure prevailing at the valve which is to be calibrated; and
evaluating an electrical signal that is present at a valve coil of the valve or at an additional measuring coil for purposes of calibration,
wherein the electrical signal is an electrical induction signal, a coil current profile, a voltage profile or any combination thereof.

21. The method as claimed in claim 20, wherein an offset current is applied to the valve coil during the calibration method.

22. The method as claimed in claim 21, wherein a valve coil current is adjusted to a predefined setpoint value by a current controller.

23. The method as claimed in claim 22, wherein a manipulated value which is modulated by a valve movement and/or an actual value of the current controller are evaluated for the purpose of calibration.

24. The method as claimed in claim 20, wherein calibration of the valve is measured by measuring an opening current value or a closing current value at a differential pressure in a vicinity of zero bar.

25. The method as claimed in claim 24, wherein in order to detect a switching point of the valve, a valve coil current is increased or decreased during the calibration method, and the switching point of the valve is detected by changing the electrical signal which is measured at the valve.

26. The method as claimed in claim 24, wherein the opening current value or closing current value acquired with the calibration method is corrected in such a way that either the opening current value or the closing current value represents a precise value for a pressure difference of zero bar within a scope of measuring accuracy.

27. The method as claimed in claim 20, wherein a periodic differential pressure is brought about by a feeding hydraulic pump which acts on the valve.

28. The method as claimed in claim 27, wherein a delivery medium which is discharged from a delivery side of the hydraulic pump and acts on the valve can escape at least partially from a circuit in which a pressure pulses.

29. The method as claimed in claim 28, wherein escapement of the delivery medium is made possible by a further, partially opened electromagnetic valve.

30. The method as claimed in claim 29 further comprising the step of calibrating an isolating valve or an inlet valve of an electrical brake control unit.

31. The method as claimed in claim 30, wherein components which are already present in the device are used to boost an amplitude of a change in the differential pressure.

32. The method as claimed in claim 31, wherein an isolating valve is partially opened when the inlet valve is being calibrated or the inlet valve is partially opened when the isolating valve is being calibrated.

33. The method as claimed in claim 32, wherein after the pressure control device has been installed in a useful application, the calibration is carried out automatically by the device without application of external pressure.

34. The method as claimed in claim 33, wherein a valve opening time or a valve closing time for the calibration is determined by evaluating an oscillation signal of a coil current curve.

35. An electronically controlled motor vehicle brake pressure control device having at least one ABS control program, said device comprising:
a pressure generating means with which pressure medium can be applied to a hydraulic assembly via pressure lines as a function of a driver's request;
isolating valves for disconnecting wheel pressure circuits from the pressure generating means;
inlet valves which are hydraulically connected to the isolating valves and the wheel pressure circuits; and
means for actively building up pressure, wherein an electronic controller of the device is configured in such a way that it can carry out a method as claimed in claim 20.

36. The device as claimed in claim 35, wherein a modulation of a differential pressure is carried out by pressure modulation with the building up pressure means.

37. The device as claimed in claim 35, wherein a valve which is to be calibrated according to the method is an inlet valve of a wheel brake cylinder or an isolating valve by which an admission pressure applied by the driver is decoupled from a region of an active pressure build up.

38. The device as claimed in claim 35, wherein a current control of at least one valve is carried out by a PWM controller.

39. The device as claimed in claim 35 further comprising an ESP control program.
